(19) United States
(12) Patent Application Publication
(10) Pub. No.: US 2026/0259713 A1
(43) Pub. Date: Sep. 3, 2026

(54) AUTOMATED SYSTEM AND METHODS FOR CONTEXTUAL CODE OPTIMIZATION

(71) Applicant: AT&T Intellectual Property I, L.P., Atlanta, GA (US)

(72) Inventors: JESSICA OWENSBY, ALPHARETTA, GA (US); Jeffrey Dix, Rowlett, TX (US); Eli Schultz, Roswell, GA (US)

(73) Assignee: AT&T Intellectual Property I, L.P., Atlanta, GA (US)

(21) Appl. No.: 19/066,569

(22) Filed: Feb. 28, 2025

(51) Int. Cl. G06F 8/41; G06F 16/31; G06F 16/35

(52) U.S. Cl. CPC G06F 8/443; G06F 16/316; G06F 16/35

(57) ABSTRACT

Aspects of the subject disclosure may include, for example, an automated code enhancement system and methods for contextual code optimization. The automated code enhancement system leverages advanced algorithms and machine learning to enhance code performance, e.g., optimizing the code, particularly in cloud-based analytics platforms. The system identifies poor-performing queries, classifies them to extract metadata, and encodes this metadata into a continuous vector space. A similarity search is conducted in an abstract representation database, e.g., a graph database, to retrieve semantically similar historic queries, which inform an artificial intelligence optimization algorithm to modify the input code segment for improved performance. The system can incorporate user feedback to refine optimization recommendations over time. This approach reduces computational costs and enhances software efficiency, providing a competitive advantage in software development and maintenance. The system is cloud-provider and platform-agnostic, significantly reducing the burden on developers. Other embodiments are disclosed.

### FIELD OF THE DISCLOSURE

The subject disclosure relates to an automated system and methods for contextual code optimization.

### BACKGROUND

Automated code optimization involves using advanced algorithms and machine learning techniques to enhance the efficiency and performance of code execution. This field includes various methods for analyzing and transforming code to decrease execution time, minimize resource consumption, and improve overall software performance. Applications of automated code optimization are found in many areas, such as cloud-based analytics platforms, software development environments, and large-scale data processing systems. These systems gain advantages from optimized code, resulting in faster processing times and reduced operational costs.

In the realm of software development and data analytics, at least one goal is to enhance the performance and efficiency of code execution. This involves reducing the computational resources required for running code, minimizing execution time, and improving the overall responsiveness of software applications. Achieving these goals allows developers to deliver faster and more reliable software solutions, which is important in today's fast-paced technological landscape. Additionally, optimized code can lead to significant cost savings, particularly in cloud-based environments where computational resources are billed based on usage.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of an automated code optimization system functioning within the communication network of FIG. 1 in accordance with various aspects described herein.

FIG. 2B is a block diagram illustrating another example, non-limiting embodiment of an automated code optimization system functioning within the communication network of FIG. 1 in accordance with various aspects described herein.

FIG. 2C is a block diagram illustrating an example, non-limiting embodiment of comparative queries as may be generated by the automated code optimization system of FIG. 2A in accordance with various aspects described herein.

FIG. 2D is a block diagram illustrating an example, non-limiting embodiment of a human-readable representation of a code segment graph as may be generated by the automated code optimization system of FIG. 2A in accordance with various aspects described herein.

FIG. 2E depicts an illustrative embodiment of an automated code optimization process in accordance with various aspects described herein.

FIG. 2F depicts another illustrative embodiment of an automated code optimization process in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for receiving a code segment, and automatically classifying it to identify metadata that is embedded within the code segment to facilitate a similarity search of other historical code segments to identify semantically similar code segments to enhance performance of the code segment in target systems, such as cloud-based analytics platforms. Other embodiments are described in the subject disclosure.

One or more aspects of the subject disclosure include a process for optimizing code. The process includes receiving an input code segment that, when submitted to a target system, causes the target system to perform an intended operation. According to the process, the input code segment is classified to obtain a classification comprising a number of classification categories. A performance indicator of the intended operation according to the input code segment is determined, wherein the performance indicator is based on at least one of the number of classification categories. Further according to the process, the plurality of classification categories are encoded into an abstract representation of the input code segment, and similarity search is performed in a database of historic code segments, including abstract representations of the historic code segments, to retrieve a group of similar code segments. The input code segment are matched to a subset of historic code segments of the group of similar code segments according to a similarity between the abstract representation of the input code segment and the abstract representations of the historic code segments to obtain a matched subset of historic code segments. Further according to the process, the input code segment is modified to obtain an optimized input code segment having optimized performance using an artificial intelligence optimization algorithm informed by the matched subset of historic code segments.

One or more aspects of the subject disclosure include a device including a processing system having a processor and a memory that stores executable instructions therein. The executable instructions, when executed by the processing system, cause the processing system to perform operations, including identifying a first code segment that, when submitted to a target system, causes the target system to perform an operation. The operations further include classifying the first code segment to obtain a classification comprising a number of classification categories and determining a performance indicator of the operation according to the first code segment, wherein the performance indicator is based on at least one of the number of classification categories. According to the operations, the number of classification categories are encoded into an abstract representation of the first code segment and a similarity search is performed in a database of historic code segments including abstract representations of the historic code segments to retrieve a group of similar code segments. The first code segment is compared to a subset of historic code segments of the group of similar code segments according to a similarity between the abstract representation of the first code segment and the abstract representations of the historic code segments to obtain a similar subset of historic code segments. The operations further include modifying the first code segment to obtain a second code segment having enhanced performance using an artificial intelligence enhancement algorithm informed by the similar subset of historic code segments.

One or more aspects of the subject disclosure include a non-transitory machine-readable medium, comprising executable instructions stored thereon that, when executed by a processing system including a processor, cause the processing system to perform operations. The operations include classifying a query to obtain a classification comprising a number of classification categories. The operations further include determining a performance indicator of the operation according to the query, wherein the performance indicator is based on at least one of the plurality of classification categories. The number of classification categories are encoded into an abstract representation of the query and a similarity search is performed in a database of historic queries including abstract representations of the historic queries to retrieve a group of similar queries. The operations further includes comparing the query to a subset of historic queries of the group of similar queries according to a similarity between the abstract representation of the query and the abstract representations of the historic queries to obtain a similar subset of historic queries and modifying the query to obtain a modified query having enhanced performance using an artificial intelligence enhancement algorithm informed by the similar subset of historic queries. These and other features will be more clearly understood from the following detailed description taken in conjunction with the accompanying drawings and claims.

Achieving optimal code performance is often hindered by several challenges. For example, a significant obstacle is the manual nature of code optimization, which requires substantial expertise and time investment from developers. Additionally, existing automated solutions may not adequately consider the specific context or metadata associated with the code, leading to suboptimal optimization results. Furthermore, the lack of a feedback loop in many systems means that optimization efforts do not evolve or improve over time, limiting their effectiveness in dynamic environments.

Current solutions for code optimization often involve manual intervention or rely on generic automated tools that do not consider specific code metadata or user feedback. These solutions generally focus on optimizing all queries without distinction, rather than targeting the queries that consume the most resources. However, these approaches have limitations in their ability to dynamically adapt to changing code contexts and user needs, leading to less efficient optimization outcomes.

The specific problem addressed by the described solution is the inefficiency of current code optimization methods, which fail to dynamically adapt to the specific context and metadata of the code being optimized. Existing solutions do not effectively leverage user feedback or focus on the most resource-intensive queries, leading to suboptimal performance improvements. The described solution aims to overcome these limitations by providing a more targeted and adaptive approach to code optimization, enhancing both the efficiency and effectiveness of the process.

The example systems, processes and computer readable media disclosed herein represent examples of an innovative approach to optimizing code execution, at least sometimes optimized within cloud-based analytics platforms, by leveraging Large Language Models (LLMs). Unlike existing solutions that require manual intervention or fail to incorporate necessary metadata and feedback loops, this disclosed techniques can be applied to identify and optimize only poor-performing queries. Poor performance may be assessed according to a predetermined performance metric, such as runtime, complexity, compute resources, and/or cost.

At least some of the example embodiments utilize a sophisticated input classifier to extract meaningful metadata, which is then embedded into an abstract representation, such as a continuous vector space, to facilitate efficient similarity searches as may be conducted within a graph database. At least some of the example embodiments allow for a dynamic optimization of code segments, e.g., queries, by matching them with semantically similar historic code segments, e.g., queries, thereby improving performance and reducing one or more of runtime, complexity compute resources, and/or computational costs. Alternatively, or in addition, at least some of the example embodiments incorporate a feedback mechanism that can be operable according to implicit feedback, explicit feedback and/or combinations thereof, to refine optimization recommendations over time, ensuring that the system evolves and adapts to user needs. In at least some embodiments, the feedback mechanism incorporates a crowd-sourced feedback. In at least some embodiments, the techniques disclosed herein can be provided as a service, e.g., according to a cloud-provider and by enabling a platform-agnostic solution to significantly reduce the burden on developers, thereby enhancing productivity and offering a competitive advantage in software development and maintenance.

By way of nonlimiting example, code optimization directed to queries in the context of the disclosed embodiments involves a systematic approach to improving the performance of database queries by reducing their execution time and resource consumption. The process is driven by a combination of advanced technologies, including LLMs, Natural Language Processing (NLP), and/or Machine Learning (ML).

In at least some embodiments, the example system, processes and/or computer readable media disclosed herein can be configured to identify poor-performing code segments, e.g., queries. For example, the top poor-performing code segments, e.g., queries, may be determined based on a performance metric, such as their runtime. This ensures that only the most resource-intensive code segments, e.g., queries, are targeted for optimization, rather than attempting to optimize all code segments/queries indiscriminately. Once a code segment/query has been identified, an input classifier algorithm is operable to extract meaningful metadata from the code segment/query. In at least some embodiments, the metadata includes details such as the code segment/query's length, knowledge domains covered, complexity, sources, expected output, and language. In at least some embodiments, the input classifier uses a preprocessing layer to clean the input, followed by NLP and/or ML layers to dynamically classify the input into decomposed metadata.

In at least some embodiments, the metadata obtained by the input classifier can be encoded into an abstract representation, such as a continuous vector space using word embedding techniques. A transformation based on an embedding of the metadata allows the metadata to be stored in an abstract representation, such as a graph database, whereby similar entities can be represented by similar abstract entities, e.g., vectors.

In at least some embodiments, a similarity search can be performed to compare an input code segment/query's metadata embeddings against those of other historical code segments, e.g., queries, stored in the graph database. By way of example, the similarity search can use a mathematical algorithm, such as a cosine similarity score to retrieve embeddings that are closest to the new query.

In at least some embodiments, the input code segment, e.g., query, can be matched with historic queries that are similar, e.g., semantically similar, as may have been determined according to the similarity search. The disclosed embodiments can be configured to consider text, metadata and a combination thereof of the code segments, e.g., queries. In at least some embodiments, different weights can be assigned to metadata attributes, e.g., based at least in part on their impact on resolving similar queries.

In at least some embodiments, new input code segments, e.g., queries, are fed into an AI enhancement algorithm, which in at least some embodiments, can include an AI optimization algorithm. The AI enhancement or optimization algorithm can be used to match the input code segment, e.g., query, to historic code segments, e.g., historic queries. In at least some embodiments, the AI enhancement or optimization algorithm is configured to use the information from similar queries to optimize the new query in an intelligent manner.

In at least some embodiments, user feedback loop can be used to facilitate optimization. For example, after enhancement or optimization, a user receives an enhanced or optimized code segment, e.g., query, output. Feedback can be obtained from equipment of the user and/or from a target system towards which the original input code segment, e.g., query was directed. This feedback can be explicit, e.g., receiving a user selection and/or other indication of a thumbs up/down, or implicit, e.g., as may be determined according to continued use of the enhanced or optimized code segment, e.g., query. The feedback loop can help to refine an optimization process over time, allowing the system and/or process to adapt and improve its recommendations.

Overall, the query optimization process disclosed herein can be designed to be dynamic, efficient, and adaptive, leveraging advanced AI techniques to reduce the burden on developers and improve the performance of cloud-based analytics platforms.

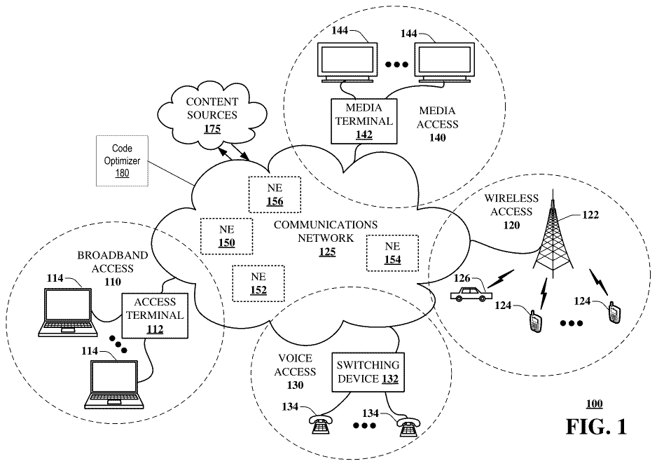

Referring now to FIG. 1, a block diagram is shown illustrating an example, non-limiting embodiment of a communication system 100 in accordance with various aspects described herein. For example, the communication system 100 can facilitate in whole or in part identification of poor-performing code segments, e.g., queries, using an automated code optimizer that, in at least some embodiments, may be employed at run time and/or just prior to runtime of the code segments to enhance, improve and/or otherwise optimize the code segment. Alternatively, or in addition, the communication system 100 can selectively apply the code segment enhancement and/or optimization to only those code segments deemed to be poor-performing. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc., for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc., can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

The example communication system 100 includes a code optimizing system 180 configured to optimize code segments. In at least some embodiments, the code optimizing system 180 is configured to identify poor-performing code segments and to optimize only those deemed to be poor performers. Other code segments may be directed to target systems for processing thereon, without having optimization applied. To the extent that the optimizing system 180 identifies a code segment, e.g., a query, as a poor performer, the code optimizing system 180 can be configured to classify the poorly performing code segment in such a manner so as to identify features that in at least some embodiments can be extracted as metadata. Alternatively, or in addition, the optimizing system 180 can be configured to encode the features of the poorly performing code segment, e.g., the metadata, into an abstract representation, such as a vector and/or a graph. In at least some embodiments, the optimizing system 180 is further configured to compare the abstract representation including the embedded metadata to other, similarly classified historical code segments, e.g., historical queries.

For example, the historical abstract representations may be stored in a database, e.g., a graph database, for comparison to the abstract representations of the poorly-performing code segment to identify similar historic code segments. In some embodiments, the abstract representations of the embedded metadata of the poorly performing code segment and the historical code segments can be arranged according to a spatial relationship. In some embodiments, the spatial relationship may be determined according to dimensionality of vector representations of the embedded metadata. Alternatively, or in addition, the spatial relationship may be determined according to a graph configuration, e.g., including nodes interconnected by edges, wherein one or more of the nodes and/or edges correspond to embedded metadata. In such instances similarity may be determined according to a distance, e.g., a cosine distance between vector representations and/or a distance determined according to one or more of the nodes and/or edges of a graph.

For example, two graphs sharing more nodes and/or edges may be considered closer than two graphs sharing fewer nodes and/or edges. It is further envisioned that in at least some embodiments, one or more of the dimensionalities of the vector representation and/or the nodes and/or edges of the graphs may be weighted, such that any determination of similarity takes into account the weighting. Consider a first pair of graphs including an abstract representation based on the input code segment and a first historical code segment share two nodes having first weighting values. Likewise, a second pair of graphs including the abstract representation based on the input code segment and a second historical code segment also share two nodes having second weighting values. They both share two nodes, but the pair having a higher weighting factor would be considered to be closer according to this example.

In at least some embodiments, the code optimizing system 180 includes an artificial intelligence (AI) code optimization algorithm. It is envisioned that in at least some embodiments, any identified similar historic code segments can be used to inform the AI optimization algorithm, e.g., to modify the input code segment for improved performance.

In at least some embodiments, the code optimizing system 180 is configured to incorporate user feedback to refine enhancement. For example, the user feedback may be used to evaluate and/or otherwise rank optimized code results. Such user feedback and/or recommendations may continue over a predetermined period of time, e.g., an evaluation period. This approach can reduce computational costs and enhances software efficiency, providing a competitive advantage in software development and maintenance.

Some approaches to code optimization can involve users manually entering code into existing large language models (LLMs) such as ChatGPT, or automatically as part of a software development lifecycle, e.g., through tools such as Github Copilot. In some approaches, code optimization, and in particular query optimization, solutions may not be automated, requiring hands-on expertise, e.g., database experts, to manually review code segments, e.g., queries, and evaluate the helpfulness of various query adjustments through trial and error, or are automated but do not take into account transactional data platform metadata or a domain and organizational specific feedback loop.

When automation is implemented, the aforementioned solutions may attempt to optimize code, e.g., queries, prior to query execution and focus on optimizing all queries. The novel techniques disclosed herein identify the top poor performing code segments, e.g., queries, by runtime and select only those deemed to be poor performers, e.g., long running, for optimization. These solutions can be further adapted to leverages crowd-sourced user input, e.g., in the form of feedback that may be implicit and/or explicit, along with the code metadata for optimization.

Such automated approaches do not rely on developers to notice which of their code segments, or queries, are the most expensive, most long running. Such an approach takes the burden of identifying poor performing queries and optimizing them off of developers and into AI. Beneficially, the disclosed techniques reduce the cost of running code, the time it takes to run that code and the time it takes for developers to learn how to optimize that code. Developer productivity resulting from this tool helps by providing a technical advantage over its competitors in creating and maintaining software.

In at least some embodiments, the code segments processed by the code optimizing system 180 are operable in and/or on equipment of a system, such as the example communication system 100. Alternatively, or in addition, the code segments processed by the code optimizing system 180 are operable on equipment of a subsystem, such as the example communications network 125, the broadband access network 110, the wireless access network 120, the voice access network 130 and/or the media access network 140. In this regard, it is understood that the code segments can be operable to modify, control and/or monitor one or more components, devices and/or equipment of the system and/or subsystem regarding functionalities thereof. It is envisioned that, to the extent the code optimizing system 180 identifies poor-performing code segments and/or optimizes those deemed to be poor performers, such performance may be based, at least in part, on an underlying operation and/or related functionality of equipment modified, controlled and/or monitored by the code segment. For example, performance may be assessed according to a system function, e.g., a network and/or communication function, such as information throughput, bandwidth, signal and/or packet delay, network congestion, and/or processing efficiency, as may be determined according to one or more of a power consumption, an equipment utilization, an associated cost, data storage requirements, and the like. In at least some embodiments, the improved and/or otherwise optimized code segments may be used to adjust equipment operations of a system and/or subsystem, such as the example communication system 100, communication network 125 and/or subsystems 110, 120, 130, 140 to adjust and/or otherwise improve operations thereof.

Other code segments may be directed to target systems for processing thereon, such as the example communication system 100 and/or example subsystems, without having optimization applied. To the extent that the optimizing system 180 identifies a code segment, e.g., a query and/or instructions, commands and/or functions related to modification, control and/or monitoring of one or more functionalities of the system and/or subsystem, as a poor performer, the code optimizing system 180 can be configured to classify the poorly performing code segment in such a manner so as to identify features that in at least some embodiments can be extracted as metadata. It is envisioned that, in at least some embodiments, the extracted features can relate to one or more of the modification, control and/or monitoring of one or more components, devices and/or equipment of the system and/or subsystem.

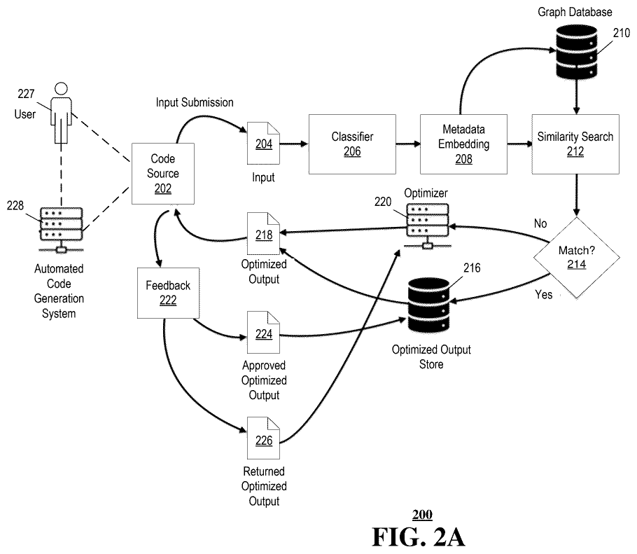

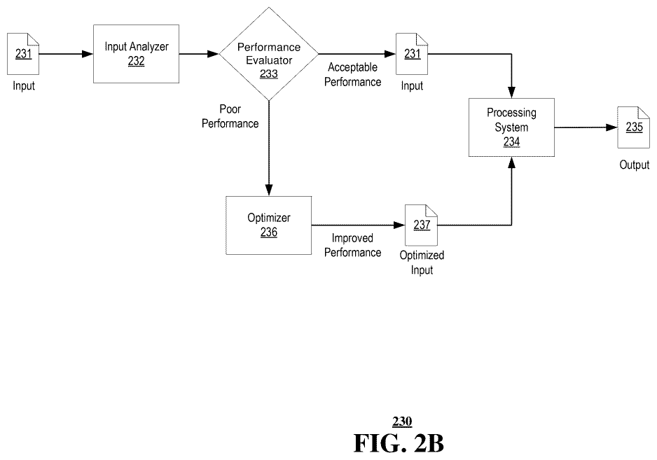

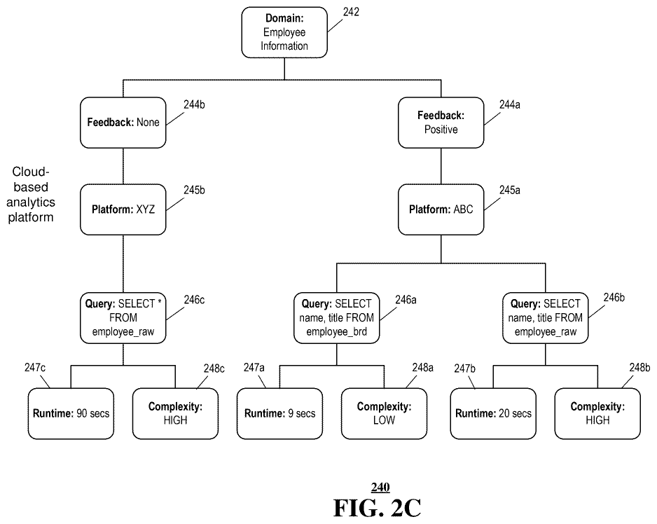

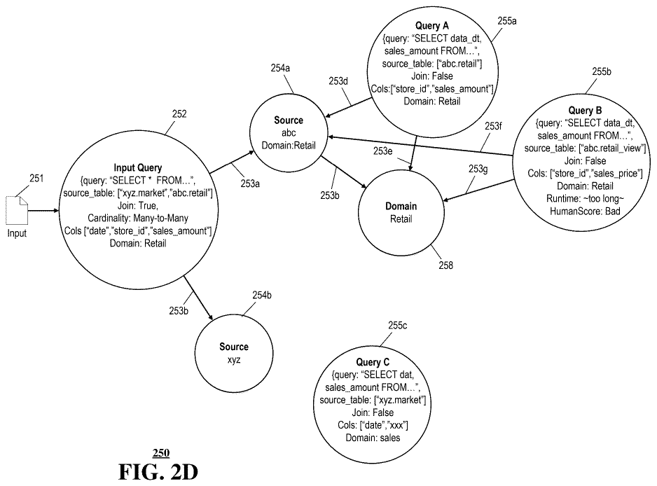

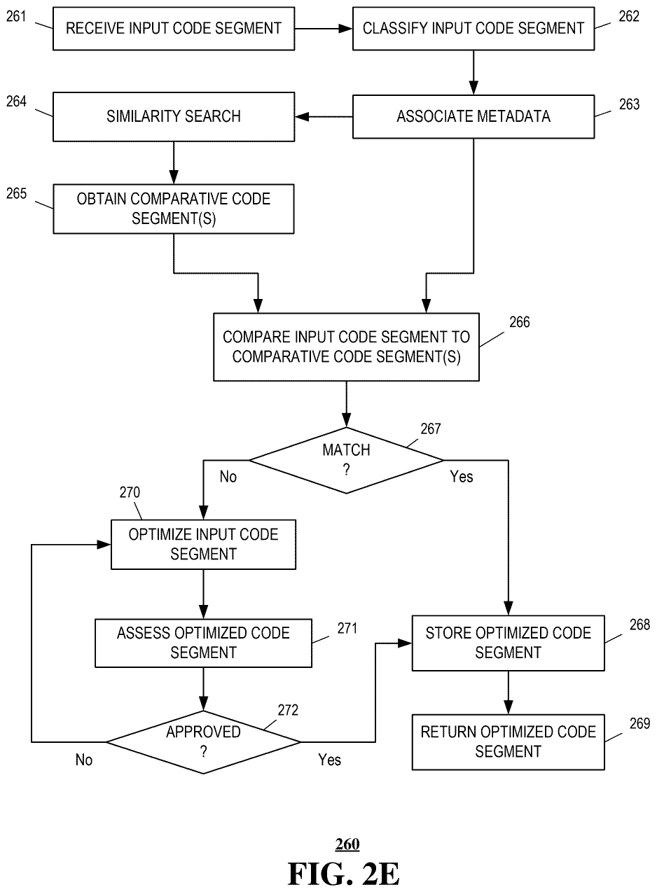

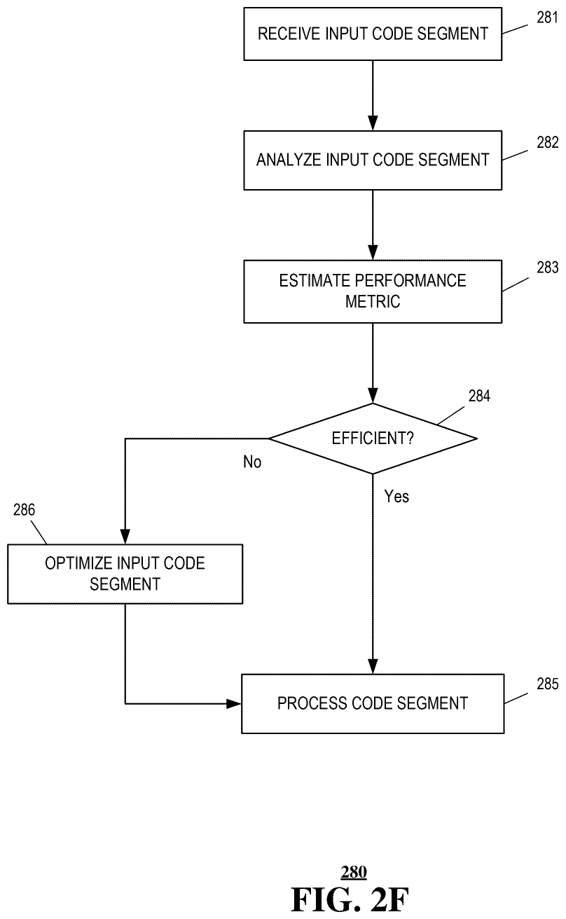

FIG. 2A is a block diagram illustrating an example, non-limiting embodiment of an automated code optimization system 200 functioning within the communication system 100 of FIG. 1 in accordance with various aspects described herein. The example automated code optimization system 200 includes a code source 202 that supplies a sample of code, referred to herein as an input code segment 204. In some embodiments, the code source module 202 receives an input from a user 227. Alternatively, or in addition, the code source module 202 receives an input code segment 204 from an automated code generation system 228. It at least some embodiments, the automated code generation system 228 includes an AI process, e.g., as in an LLM that has been suitably trained and/or otherwise configured to generate the input code segment 204, e.g., based upon a natural langue prompt. The example automated code optimization system 200 further includes an input classifier module 206 configured to receive the input code segment 204, to classify the input code segment 204, and to provide a classification result. It is understood that in at least some embodiments, the classification result may include metadata associated with one or more aspects related to the input code segment.

The example automated code optimization system 200 further includes an embedding module 208. The embedding module 208 is in communication with the input classifier module 206 and, in at least some embodiments, receives at least one of the input code segment or a classification result, e.g., metadata. In at least some embodiments, the embedding module 208 is configured to process the output of the input classifier module 206 according to an embedding algorithm or process.

The example automated code optimization system 200 further includes a historical records repository configured to store information related to historical code segments. In at least some embodiments, the other historical code segments represent code segments previously processed by the automated code optimization system 200. It is envisioned that the information related to the historical code segments may include metadata associated with the code segments, and in at least some embodiments, the code segments themselves. According to the illustrative example, the historical records repository includes a graph database 210. In at least some embodiments, the graph database may be configured to store abstract representations of the code segments and/or the associated metadata. Abstract representations may include, without limitation, vectors and/or graphs as may correspond to the example schema design for graph data shown in FIG. 2D.

The example automated code optimization system 200 further includes a similarity search module 212 in communication with one or more of the metadata embedding module 208 and/or the graph database 210. The similarity search module 212 can be configured to identify one or more similar historical code segments from the graph database 210 based at least in part on the embedded metadata provided by the metadata embedding module 208.

In at least some embodiments, the example automated code optimization system 200 further includes match determining module 214. The match determining module 214 can be configured to receive information from the similarity search module 212. For example, the match determining module 214 can be configured to receive a group of similar historical code segments as may have been identified by the similarity search module 212. The match determining module 214 may evaluate the group of similar historical code segments, e.g., according to one or more of the code segments themselves, metadata associated with the code segments and/or a measure of similarity, e.g., “closeness,” as may have been determined by similarity search module. The match determining module 214 may select a subset of the group of similar code segments, e.g., the best alternative, as a matching code segment. Determination of the best alternative may be based at least in part on the closeness, the metadata, and/or the code segments themselves.

To the extent a suitable match has been determined by the match determining module 214, the matching historical code segment may be provided to an enhanced or optimized output storage facility, e.g., an optimize output database 216. In at least some embodiments, the optimized output database 216 may retain an association of the original input code segment 204 and the optimized output 218. The optimized output code segment 218, in turn, may be presented for review, e.g., feedback according to the example feedback module 222. The feedback module 222 may be adapted to determine an approval of the optimized output code segment 218 to obtain an approved optimized output 224 or a rejection of the optimized output 218, e.g., based on feedback from the code source 202. In at least some embodiments, the feedback may be explicit, as in receiving a positive indication, e.g., a thumbs up, or a negative indication, e.g., a thumbs down, from equipment of a user 227. Alternatively, or in addition, the feedback module 222 may be operable to detect implicit feedback indicative of an approval and/or disapproval. For example, implicit feedback may be determined based on a subsequent usage of the optimized output code segment 218.

To the extent that the feedback module 222 indicates that the optimized output 218 has been approved, an approved optimized output 224, based on the optimized output 218, can be stored in the optimized output database 216. To the extent that the feedback module 222 indicates that the optimized output 218 has been disapproved, a returned optimized output 226, based on the optimized output 218, can be resubmitted to the optimizer 220 for further optimization. It is envisioned that the process may be repeated, e.g., iterated, until some threshold number of iterations and/or time interval has expired, and/or until either the optimized output 218 has been approved by the feedback module 222 or until the user has terminated the process.

Once the user 227 receives the optimized output 218, they can be given an opportunity to evaluate the suggested output, e.g., a prompt on a user interface, a text message, an audible prompt, and the like. Tho the extent that the optimized output 218 is deemed unacceptable, e.g., according to the feedback process, the optimized output 218 and/or the original input code segment 204 can be returned to the optimizer module 220 for further optimization. This process can be repeated until the user is satisfied. Alternatively, the user 227 may not provide any feedback on the optimized query and may begin to immediately use the optimized query. It is understood that execution of a new code segment, e.g., a new query, on a target processing system and/or application may be detectable, such that an implicit approval of the optimized query may be inferred when the user 227 simply begins using the optimized output 218. It is recognized that providing human-in-the-loop feedback can facilitate a proper tuning of the code.

In at least some embodiments, storage of the optimized output code segment 218 in the optimize output database 216 can be subject to an approval as determined by the feedback module 222 to obtain an approved optimized output 224. Alternatively, or in addition, storage of the optimized output code segment 218 may be stored in association with an indication of approval and/or disapproval. In at least some embodiments, the match determining module 214 may consult the optimized output database 216 before determining a match to identify whether an anticipated matching historical code segment has been previously stored therein and/or whether the anticipated matching historical code segment was previous approved or disapproved.

To the extent a suitable match has not been determined by the match determining module 214, the input code segment alone or in combination with one or more of the similar historical code segments may be provided to an optimizer module 220. The optimizer module 220 can be configured to generate an optimized output 218, e.g., a new optimized output that may not have been captured in the historical code segments. The optimized output code segment 218, in turn, may be presented for review, e.g., feedback according to the example feedback module 222 as discussed above, in which instance, the feedback module 222 may be adapted to determine an approval of the optimized output code segment 218 or a rejection of the optimized output 218, e.g., based on feedback from the code source 202, and so on.

In at least some embodiments, the optimizer module 220 receives output of the historic matches from the match determining module 214 along with the input code segment 204 and applies an AI optimization algorithm for optimization of the input code segment 204 in view of the historic matches to obtain the optimized output 218. The optimized output code segment 218, in turn, may be presented for review, e.g., feedback according to the example feedback module 222 as discussed above, in which instance, the feedback module 222 may be adapted to determine an approval of the optimized output code segment 218 or a rejection of the optimized output 218, e.g., based on feedback from the code source 202, and so on.

In more detail, and at least some embodiments, the input classifier module 206 can include an input classifier algorithm. The input classifier algorithm is configured to extract the meaningful metadata about at least some and up to all relevant details of the input code segment. To this end, the input classifier algorithm can be configured to decompose the input code segment into a group of elements, such as an array of component classes. By way of nonlimiting example, the component classes can include one or more of a length of the input code segment, and/or one or more domains, e.g., knowledge domains, associated with the input code segment. Alternatively, or in addition, other component classes can include complexity of the input code segment within any of the one or more domains and/or an indication of an overall complexity of the input code segment. Still other component classes can include, without limitation, one or more sources associated with the input code segment, e.g., libraries, databases, other processing systems, expected output, a language of the input code segment, to name a few.

In at least some embodiment, the input classifier module 206 can include a preprocessing function. For example, the classifier algorithm can be made up of a number of functions or routines, sometimes grouped according to a layered structure, e.g., a preprocessing layer, a Natural Language Processing (NLP) layer, and/or a Machine Learning (ML) layer. According to the illustrative example, the input code segment can be converted to text and preprocessed, e.g., to remove any unnecessary information, such as extra whitespace, bad characters and/or other artifacts deemed detrimental to one or more of the remaining layers. In at least some embodiments, the preprocessing layer can be configured to extract key words from the text, e.g., based on a corpus of defined patterns, which can include but need not be limited to language specific words or patterns, for example the Standard Query Language (SQL) pattern for comments, query statement, source tables, column names, functions, etc.

In at least some embodiments, the input classifier module 206 can incorporate automation, e.g., in the form of AI. For example, preprocessed data from the preprocessing layer can be passed to the NLP layer, which may include a transformer model adapted to dynamically classify pieces of input into the decomposed metadata. In at least some configurations, the transformer model may be adapted to create features based on input semantics. For metadata entities with either finite classes or numeric output, where NLP may not be cost effective or not accurate, such as calculating predicted runtime based on existence of functions (i.e., presence of cross join with subquery based on historic data on similar data sources) the features can be identified and/or otherwise created at least partially in the ML layer. In at least some embodiments, features may be created in both the preprocessing and NLP layers can be used as input to a dynamic suite of models trained for entity classification/regression.

In more detail, and at least some embodiments, the metadata embedding module 208 can be configured to group metadata from the input classifier into different attributes. Example attributes can include, without limitation, domains, data sources, and/or code complexity. By way of example, entities that are text based, such as the query or domain, can be encoded to an abstract structure, e.g., a continuous vector space, via word embedding. In at least some embodiments, the abstract structures, e.g., vectors, can be passed through a transformer model to obtain output vectors. The output vectors may then be stored in a suitable storage structure, e.g., a graph database, in which entities that are similar may be represented as similar vectors.

In more detail, and at least some embodiments, the similarity search module 212 can be configured to determine if a new code segment, e.g., query, matches historic code segments, e.g., queries. By way of example, the similarity search module 212 can be configured to compare the metadata embeddings from the new code segment or query against previous code segments or queries. It is understood that in at least some embodiments, the comparisons can be performed on abstract structures, such as the example embeddings, available in the storage repository, e.g., the graph database 210. By way of example, similarity may be determined according to a mathematical process, such as a cosine similarity score between the input code segment and historical code segments. Alternatively, or in addition, similarity or closeness may be determined according to a graphical process, e.g., comparing a graphical representation of the input code segment, e.g., the vector, to a graphical representation of the historical code segments. Embeddings that are the closest can be identified and/or otherwise retrieved from the graph database 210.

In more detail, and at least some embodiments, the matching module 214 can be configured to compare the input code segment, e.g., query, with a group of the closest historic code segments or queries to obtain a matching historical code segment or query. By way of example, the input code segment or query is first encoded, e.g., by the classifier module 206 and the metadata embedding module 208. A similarity search is preformed by the similarity search module 212 to find historic code segments or queries that are the closest in terms of some measure, such as semantic similarity. It can be appreciated that the input code, e.g., the text, from two queries can be semantically similar, but represent unrelated queries. In at least some embodiments, the matching module 214 can be configured to examine and/or otherwise evaluate the metadata associated with the graph database retrieved queries. Metadata attributes can be given different weights, e.g., based on their perceived impact to resolving similar queries. For example, a domain attribute may be weighted higher that a complexity attribute, so if there are two queries historic queries that match the new query, a greater preference may be given to the query in the same domain.

FIG. 2B is a block diagram illustrating another example, non-limiting embodiment of an automated code optimization system 230 functioning within the communication system 100 of FIG. 1 in accordance with various aspects described herein. The automated code optimization system 230 includes an input analyzer 232 configured to receive an input code segment 231, e.g., a query, and to perform an analysis based upon the input code segment and to provide an analysis result. In at least some embodiments, the analysis may be adapted to identify one or more aspects of the input code segment 231 related to a performance of the input code segment and to provide the analysis result indicative of the performance aspects.

The automated code optimization system 230 further includes a performance evaluator 233. The performance evaluator 233 can be configured to receive the analysis result and/or the input code segment 231 and to evaluate whether a perceived and/or otherwise estimated performance of the input code segment 231 is acceptable or unacceptable based on the input code segment 231, the analysis result, or a combination thereof. Without limitation, performance may be determined based on one or more of an estimated runtime of the input code segment 231, and estimated computational complexity associated with the input code segment 231. A perceived cost associated with any combination of one or more of an execution of the input code segment, a length of the input code segment 231, a language of the input code segment 231, other systems and/or databases accessed by the input code segment 231, and so on.

In response to a determination of an input code segment 231 not being unacceptable, the input code segment 231 can be identified as being suitable for further processing by a target processing system 234, e.g., to perform the intended function of the input code segment 231. For situations in which the input code segment is a query, the input 231 can be passed to a database processing system or systems in order to obtain a suitable output 235, e.g., a query response.

In response to a determination of an input code segment 231 being unacceptable, the input code segment 231 can be passed to a code segment optimizer 236. A determination of an input code segment being unacceptable generally relates to a perception that the input code segment would be a poor performer when submitted to a target system, e.g., the example target processing system 234 for execution thereon. In at least some embodiments, the code optimizer 236 can include one or more of the features of the automated code optimization system 200 (FIG. 2A), including up to the entire automated code optimization system 200. The code segment optimizer 236 produces an optimized input code segment 237 that can be passed to the target processing system 234 for processing thereon.

It is understood that in at least some embodiments, the automated code optimization system 230 can be configured to operate at runtime and/or just prior to runtime. In this instance, runtime can include a relatively short period of time preceding submission of the input code segment 231 to the target system 234. For example, the automated code optimization system 230 may be incorporated into an input code segment generation system, such that the corresponding functionality may be applied as an automated step initiated by submission of the input code segment 231 for execution on the target system 234. In this configuration, the automated code optimization system 230 would perform an interstitial analysis to determine whether the input code segment 231 is a poor performer and undertake an enhancement and/or optimization process only for those input code segments perceived to be poor performers. Otherwise, the input code segment 231 may be passed to the target processing system 234 with only a slight delay as may be associated with making such a determination.

To the extent that the input code segment 231 is perceived to be a poor performer, the optimization process may be initiated automatically. In some embodiments, the automated code optimization system 230 may be configured to provide an indication to a user, e.g., a message and/or a prompt that optimization is recommended. The user may have an option to proceed without optimization, possibly opting to forego optimization or to perform optimization at some later time, e.g., associated with a subsequent submission of the same or similar input code segment 231. Alternatively, or in addition, the automated code optimization system 230 may be configured to automatically initiate optimization. To the extent that optimization requires user input, e.g., feedback, the user may be provided with a recommendation and/or a suggestion and/or a modified input code segment 231, e.g., representing an enhanced or optimized code segment 237.

FIG. 2C is a block diagram illustrating an example, non-limiting embodiment of comparative queries 240 as may be generated by the automated code optimization system 200 of FIG. 2A in accordance with various aspects described herein. According to the illustrative example, an input code segment is a query. According to an evaluation and/or assessment of the input code segment, comparative queries 240 according to a human-readable arrangement of similar queries is illustrated. In this example, three queries are provided in a fourth layer of the example comparative queries 240. A first query 246a is run in a domain 242 of employee information. The first query 246a is also run on a first platform 245a, i.e., platform “ABC” with a resulting first runtime 247a of 9 seconds, and having a first complexity 248 a determined to be “Low.” Likewise, a second query 246b is run in the same domain 242 and on the first platform 245a with a resulting second runtime 247b of 20 seconds and having a second complexity 248b determined to be “High.” The example comparative queries indicates that both of the first and second queries 246a, 246 have received feedback 244a indicated as “Positive.” A third query 246c is run in the same domain 242 but on a different, second platform 245b, i.e., platform “XYZ” with a resulting third runtime 247 c of 90 seconds, and having a third complexity 248c determined to be “High.” The third query 246c has not received feedback 244b indicated as “None.”

According to the illustrative example, the third query 246c may represent an input query as may have been provided by an input code source. The first and second queries 246a, 246b may represent historical queries identified by the automated code optimization system 200, 230 (FIGS. 2A, 2B). In this instance, all three queries may be deemed as being semantically similar, e.g., related to the same domain 242. It is apparent that either of the first and second queries 246a, 246b exhibits a significantly shorter runtime 247a, 247b and both have positive feedback 244a. Accordingly, either may represent a suitably enhanced alternative to the third query 246c. It is further apparent that the first and second queries 246a, 246b exhibit different complexities 248a, 248b. Accordingly, one or another of the first and second queries 246a, 246b may represent an optimized alternative to the third query 246c, depending upon whether a runtime 247a, 247b or a complexity 248a, 248b factors into a greater importance in view of the third query 246c. This illustrative example shows how metadata, such as domain 242, runtime 247a, 247b, 247c, generally 247, platform 245a, 245b, generally 245, and user feedback 244a, 244b, generally 244 may factor into an enhancement or optimization process.

FIG. 2D is a block diagram illustrating an example, non-limiting embodiment of a human-readable representation of a code segment graph 250, e.g., according to a schema design for graph data, as may be generated by the automated code optimization system 200 of FIG. 2A in accordance with various aspects described herein. The example code segment graph 250 includes an input node 252 representing an Input Query as may correspond to an input code segment, or in this instance, an input query 251. The example code segment graph 250 includes other nodes 255a, 255b, 255c, generally 255, corresponding to other input queries. Namely a first one of the other nodes 255a corresponds to a second query, i.e., Query A, a second one of the other nodes 255b corresponds to a third query, i.e., Query B, and a third one of the other nodes 255c corresponds to a fourth query, i.e., Query C. The example code segment graph 250 includes three other nodes: a first source node 254a, a second source node 254b and a domain node 258.

The input node 252 is connected to the first source node 254a via a first edge 253a, e.g., signifying that the Input Query relies upon the first source 254a, i.e., “abc.” Likewise, the input node 252 is also connected to the second source node 254b via a second edge 253b, e.g., signifying that the Input Query also relies upon the second source 254b, i.e., “xyz.” The first source node 254a is also connected to the domain node 258 via a third edge 253b, e.g., signifying that the source “abc” is associated with the domain “Retail.”

The first other node 255a is connected to the first source node 254a via a fourth edge 253d, e.g., signifying that Query A also relies upon the first source 254a, i.e., “abc” and to the domain node 258 via fifth edge 253e, signifying that Query A also relies upon the same domain 258. Similarly, the second other node 255b is also connected to the first source node 254a via a sixth edge 253f, e.g., signifying that Query B also relies upon the first source 254a, i.e., “abc” and to the domain node 258 via seventh edge 253g, signifying that Query B also relies upon the same domain 258. The third other node 255c is connected to neither of the first source node 254a, the second source node 254b or the domain node 258.

It is apparent from the example code segment graph 250 that Query A and/or Query B may exhibit at least a greater similarity to the Input Query than Query C, at least based on the source nodes 254 and the domain node 258. Accordingly one or both of Query A and Query B may be returned to a submission of the Input Query, at least to the extent they may represent enhanced and/or otherwise optimized versions of the Input Query. Query C, on the other hand, may or may not be returned to a submission of the Input Query based on one or more factors, such as the various examples disclosed herein.

FIG. 2E depicts an illustrative embodiment of an automated code optimization process 260 in accordance with various aspects described herein. The process begins at step 261, by receiving an input code segment. In at least some embodiments, the input code segment includes human readable code as may relate to a computer program, a script and/or a query. The input code segment can be used to control operation of a processing system, such as a computer system, a communication system, a database system, a machine automation system, a gaming system and so on. In step 262, the input code segment is classified to identify relevant categories. The categories can include, without limitation, any information related to the code segment, e.g., a language used in the code segment, a target system upon which the code segment may affect operations, subject matter of the code segment, e.g., a database of a query code segment, semantic information, and so on.

Further according to the example process 260, at step 263, metadata is associated with the input code segment. In at least some embodiments, the metadata includes some or all of the categories determined at step 262. The process 260 then performs a similarity search at step 264 to find comparative code segments. It is envisioned that similarity can be determined according to at least some of the metadata, e.g., according to one or more of the example categories. In at least some embodiments, one of the input code segment, the metadata or a combination thereof can be embedded into an abstract representation of the input code segment. By way of nonlimiting example, the information can be embedded into a vector representation, e.g., based on multiple bases determined according to information, such as the example metadata.

At step 265, the system obtains these comparative code segments. In at least some embodiments, the comparative code segments include historical code segments that can be stored in a datastore structure, such as a database. In at least some embodiments, at least some of the historical code segments are stored according to abstract representations that may correspond to the abstract representation of the input code segment, e.g., in a vector representation according to one or more of the same bases, and/or similar bases. It is understood that in at least some embodiments, at least some of the comparative code segments may include semantic similarities to the input code segment.

Further according to the example process 260, at step 266, the input code segment is compared to the comparative code segments. To the extent that the input code segment and the historical code segments are represented in suitable abstract representations, e.g., vector representations and/or graphical representations, the example process 260 can obtain a comparison. For example, in at least some embodiments, the comparison may be obtained in a mathematical sense, e.g., determining a distance between an abstract representation of the input code segment as may be represented by a first vector and/or a first graph and at least one of the historical code segments as may also be represented by a second vector and/or a second graph. At least in the context of vector space, a cosine distance may be determined as a measure of “closeness” or similarity between the compared code segments. Alternatively, or in addition, closeness or similarity between graphical representations may be measured according to measures of common nodes, common edges, semantically similar nodes and/or edges, and the like.

According to the example process 260, a decision is made at 267 as to whether there is a similarity or match. It is understood that similarity may be determined according to a threshold, e.g., a sufficient similarity, as may be measured and/or otherwise estimated according to the aforementioned quantification of closeness. If a match is found, the process 260 proceeds to step 268, where the optimized code segment may be stored, and then to step 269, where it may be returned to the user. In at least some embodiments, a suitably similar code may be provided together with other suitable samples, e.g., as a text file, in a graphical user display, in a table and/or group to provide alternatives that may be evaluated and/or otherwise compared to determine a preferred one or more from among a group of sufficiently similar alternatives.

If no match is found, the process 260 moves to step 270, where the input code segment can be modified and/or otherwise enhanced, e.g., optimized. Enhancement, e.g., optimization, can be performed using various techniques, including manual optimization, automatic optimization and/or combinations of manual and automatic optimization. In at least some embodiments, automated optimization can include an application of artificial intelligence (AI). For example, an AI transformer mode may be trained to incorporate one or more features, as may be captured by neurons, possibly including embedded layers of neurons, to enhance an input code segment. Accordingly, an input code segment may presented to a suitably trained model, which provides a modified code segment, incorporating an enhancement upon which the model was trained, e.g., optimization of one or more performance metrics. In at least some embodiments, enhancement can be measured according to a performance metric, such as a runtime, a computational complexity, types of systems utilized, types of supporting systems and/or data, e.g., databases, any of which may incur cost values, e.g., for access.

In at least some embodiments, the enhanced, e.g., optimized, code segment can then be assessed at step 271. Assessment may include an evaluation of one or more performance metrics, e.g., runtime, cost, complexity, as may be reported along with the enhanced code segment. To the extent the decision point 272 determines that the optimization is approved, the process 260 may conclude. To the extent the decision point 272 determines that the optimization is not approved, the process 260 may proceed to undertake further enhancement, e.g., optimization, e.g., returning to step 270.

In at least some embodiments, the decision point 272 may be determined explicitly, e.g., based on user feedback as may be provided via a user interface as to the acceptability and/or unacceptability of the enhanced code segment. Alternatively, or in addition, the decision point 272 may be determined implicitly, e.g., based on an inference as may be based on a determination, e.g., a detection, that the enhanced code may have been used and/or otherwise applied to a target system. Such detected use may be understood to infer an acceptance at decision point 272, while lack of use, at least within some sample period, may be understood to infer an unacceptance at decision point 272. In this manner, the suitability of an enhanced, e.g., optimized, code segment may be determined according to user feedback, which in at least some embodiments may be determined according to crowd sourcing a measure of acceptability. In at least some embodiments, user feedback as may be obtained by positive and/or negative feedback may be stored along with the enhanced code segments in an enhanced code segment data store, e.g., database.

FIG. 2F depicts another illustrative embodiment of an automated code optimization process 280 in accordance with various aspects described herein. The process begins at step 281, where the system receives the input code segment. In at least some embodiments, the code segment includes human readable code as may relate to a computer program, a script and/or a query. The code segment can be used to control operation of a processing system, such as a computer system, a communication system, a database system, machine automation, gaming and so on. In step 282, the input code segment is analyzed to extract relevant information. The information obtained by such an analysis can include any information related to the code segment, e.g., a language used in the code segment, a target system upon which the code segment may affect operations, subject matter of the code segment, e.g., a database of a query code segment, semantic information, and so on. Following this, step 283 involves estimating a performance metric related to execution of the code segment based on the analysis. At decision point 284, the process 280 determines whether the code segment is efficient based on the performance metric. To the extent it is determined at 284 that the code segment is efficient, the process 280 proceeds to step 285, where the code segment is processed as is. In other words, the efficiency of the original input code segment is deemed to be efficient and therefore usable without modification. Alternatively, to the extent it is determined at 284 that the code segment is not efficient, the process 280 moves to step 286, where the input code segment is modified, e.g., optimized, to enhance its performance at least as measured according to the example performance metric. This flowchart of the automated code optimization process 280 represents decision-making and modification, e.g., optimization, steps as may be undertaken by a system, such as the example systems of FIGS. 1, 2A and 2B to ensure code efficiency and performance improvement.

While for purposes of simplicity of explanation, the respective processes are shown and described as a series of blocks in FIGS. 2E and 2F, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

Cloud-based analytics platforms provide users with the ability to execute code with on-demand computational resources, however developers often write unoptimized code which is less performant and thus requires more time and resource to run. It is a common sentiment in the developer community today that a large portion of code could be further optimized. Cloud providers generally benefit from more compute used, and thus are not incentivized to build in methods for cost optimization.

The systems, processes and computer readable media disclosed herein address this enhancement or optimization problem in a cloud-provider and platform-agnostic approach by using a system and methods for LLM driven code optimization. At a high level, a user submits code as part of their normal workflow where it is automatically input into one or more of the example algorithms and/or processes disclosed herein to be dynamically optimized. It is understood that in at least some embodiments, the enhanced, e.g., optimized, code can be returned to the user for execution, based on the input code segment, e.g., query, itself and metadata matches of semantically similar code segments, e.g., queries. In at least some embodiments, the code enhancement techniques can incorporate a user feedback loop that in at least some variations can include a crowd-sourced feedback loop. As described herein the feedback can include explicit feedback and/or implicit feedback as may be gleaned from use of an optimized query output. Consequently, the disclosed systems, processes and computer readable media can be operable to improve optimization recommendations over time. The improvements may result at least in part from one or more of generation of additional historical code segments for comparison, additional user feedback to optimized code segments, and/or crowd-sourced feedback.

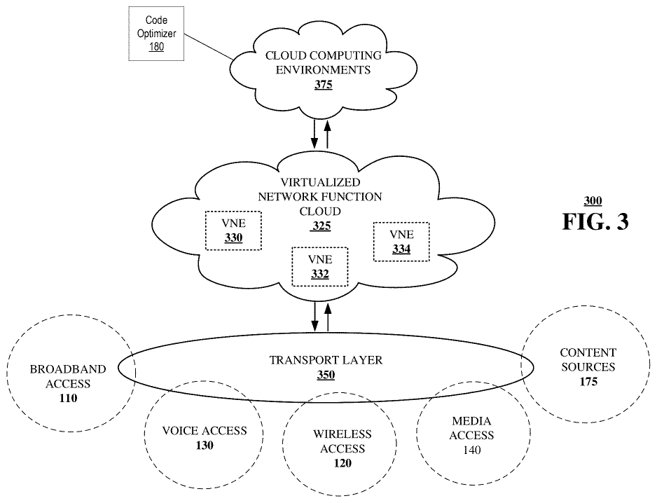

Referring now to FIG. 3, a block diagram is shown illustrating an example, non-limiting embodiment of a virtualized communication network 300 in accordance with various aspects described herein. In particular a virtualized communication network is presented that can be used to implement some or all of the subsystems and functions of systems 100, 200, 230, 300 and processes 260 and 280 presented in FIGS. 1, 2A, 2B, 2E, 2F and 3. For example, virtualized communication network 300 can facilitate in whole or in part identification of poor-performing code segments, e.g., queries, using an automated code optimizer that, in at least some embodiments, may be employed at run time and/or just prior to runtime of the code segments to enhance, improve and/or otherwise optimize the code segment. Alternatively, or in addition, the communication system 100 can selectively apply the code segment enhancement and/or optimization to only those code segments deemed to be poor-performing.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements-which are typically integrated to perform a single function, the virtualized communication network employs virtual network elements (VNEs) 330, 332, 334, etc., that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc., to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers-each of which adds a portion of the capability, and which creates an elastic function with higher availability overall than its former monolithic version. These virtual network elements 330, 332, 334, etc., can be instantiated and managed using an orchestration approach similar to those used in cloud compute services.

The cloud computing environments 375 can interface with the virtualized network function cloud 325 via APIs that expose functional capabilities of the VNEs 330, 332, 334, etc., to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

A cloud-based analytics platform can include a service or solution that provides data analytics capabilities over the internet, leveraging cloud computing infrastructure. These platforms can allow users to perform data analysis, processing, and visualization without the need for on-premises hardware or software. Key characteristics of cloud-based analytics platforms include, without limitation, one or more of scalability, accessibility, cost-effectiveness, integration, advanced analytics, security and compliance.

Namely, a cloud-based analytics platform can easily scale resources up or down based on the volume of data and the complexity of analytics tasks, accommodating varying workloads efficiently. Users can generally access the platform from anywhere with an internet connection, enabling remote collaboration and data sharing and, by using a pay-as-you-go model, these platforms can reduce the need for significant upfront investment in hardware and software, allowing organizations to pay only for the resources they use. Additionally, cloud-based analytics platforms often integrate with various data sources, including databases, data lakes, and third-party applications, facilitating comprehensive data analysis, at times offering advanced analytics capabilities, such as machine learning, artificial intelligence, and real-time data processing. Moreover, cloud-based analytics platforms typically include robust security measures and compliance certifications to protect sensitive data and meet regulatory requirements.

Examples of cloud-based analytics platforms include services like Google Cloud Platform's BigQuery, Amazon Web Services' Redshift, Microsoft Azure's Synapse Analytics, and Snowflake. These platforms are widely used by businesses to gain insights from large datasets, improve decision-making, and enhance operational efficiency.

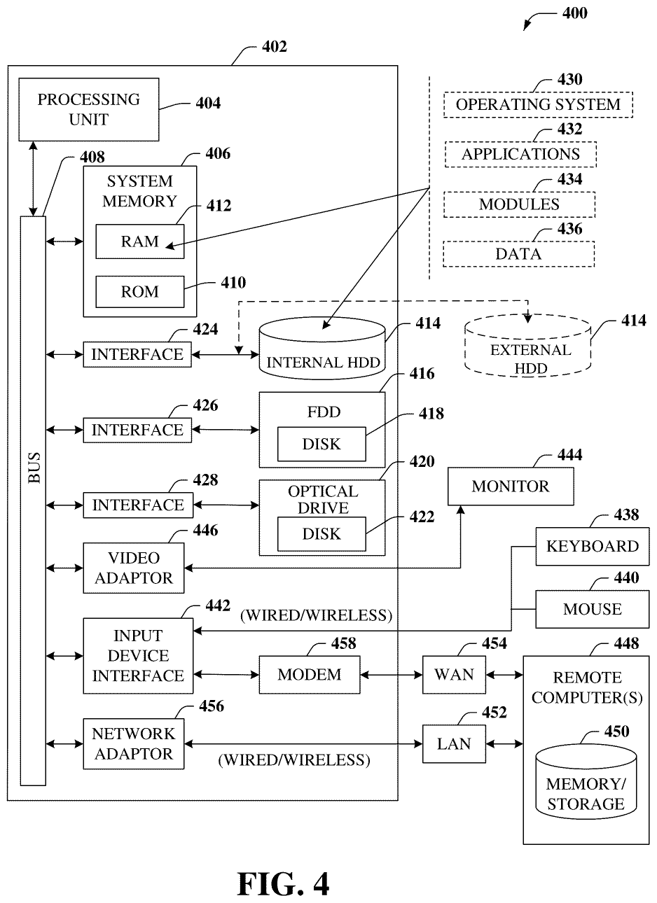

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part identification of poor-performing code segments, e.g., queries, using an automated code optimizer that, in at least some embodiments, may be employed at run time and/or just prior to runtime of the code segments to enhance, improve and/or otherwise optimize the code segment.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

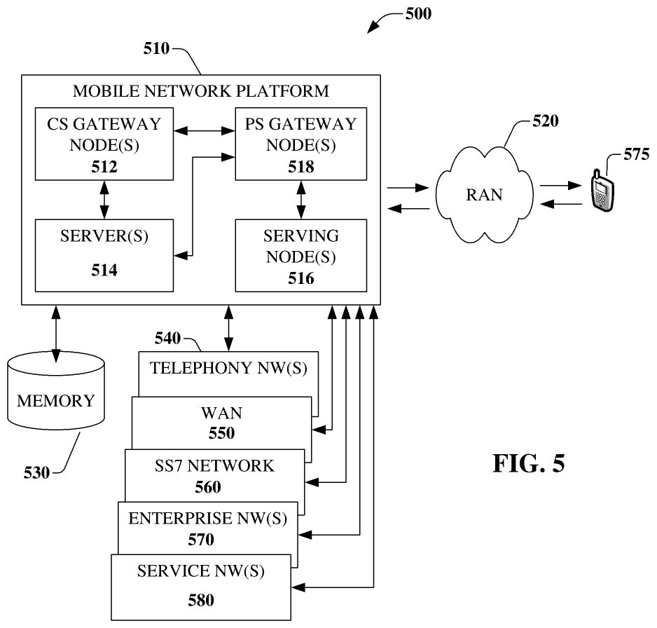

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part identification of poor-performing code segments, e.g., queries, using an automated code optimizer that, in at least some embodiments, may be employed at run time and/or just prior to runtime of the code segments to enhance, improve and/or otherwise optimize the code segment. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format ...) such flows. Such application(s) can comprise add-on features to standard services (for example, provisioning, billing, customer support ...) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc., that perform particular tasks and/or implement particular abstract data types.

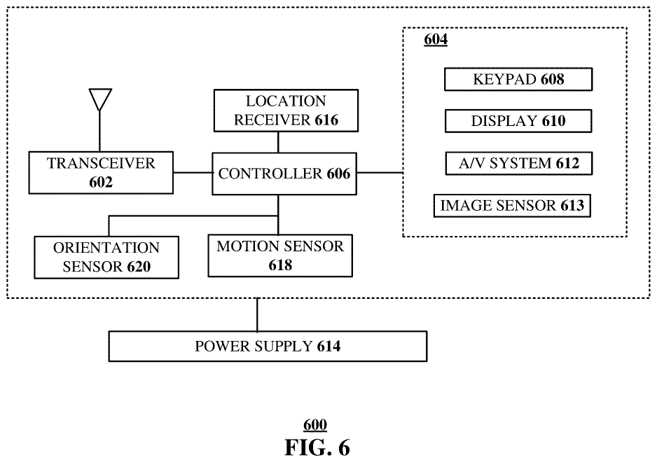

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part identification of poor-performing code segments, e.g., queries, using an automated code optimizer that, in at least some embodiments, may be employed at run time and/or just prior to runtime of the code segments to enhance, improve and/or otherwise optimize the code segment.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

In the context of this disclosure, the terms “code” and “query” have distinct meanings, although they are related. It is understood that code can refer to any set of instructions written in a programming language, including natural language scripts, that are intended to be operable upon a target system, e.g., executed by a processing system that may include a computer. Accordingly, code can encompass a wide range of functionalities, including algorithms, data processing, user interface logic, and more. It is a broad term that includes all types of programming scripts, applications, and software components. Code can be written in various languages such as Python, Java, C++, etc., and is not limited to database interactions.

It is understood that a query represents a specific type of code that may be used to retrieve and/or otherwise manipulate data within a database. Queries are often written in a query language, such as SQL (Structured Query Language), and are designed to perform operations like selecting, inserting, updating, or deleting data from a database. Queries are generally focused on data retrieval and manipulation, and they often involve specifying criteria for data selection, such as filtering conditions, sorting, and grouping.

In summary, while all queries are a form of code, not all code is a query. Queries are specialized code segments that interact with databases, whereas code, in general, can perform a wide array of computational tasks beyond database operations. The disclosure focuses on optimizing queries specifically, as they are often resource-intensive and critical for efficient data processing in cloud-based analytics platforms.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ ... xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A method for optimizing code, comprising:
receiving, by a processing system including a processor, an input code segment that, when submitted to a target system, causes the target system to perform an intended operation;
classifying, by the processing system, the input code segment to obtain a classification comprising a plurality of classification categories;
determining, by the processing system, a performance indicator of the intended operation according to the input code segment, wherein the performance indicator is based on at least one of the plurality of classification categories;
responsive to the performance indicator indicating a poor performance of the intended operation according to the input code segment:
encoding, by the processing system, the plurality of classification categories into an abstract representation of the input code segment;
performing, by the processing system, a similarity search in a database of historic code segments comprising abstract representations of the historic code segments to retrieve a group of similar code segments;
matching, by the processing system, the input code segment to a subset of historic code segments of the group of similar code segments according to a similarity between the abstract representation of the input code segment and the abstract representations of the historic code segments to obtain a matched subset of historic code segments; and
modifying, by the processing system, the input code segment to obtain an optimized input code segment having optimized performance using an artificial intelligence optimization algorithm informed by the matched subset of historic code segments.

2. The method of claim 1, wherein the input code segment comprises a query.

3. The method of claim 2, wherein the plurality of classification categories comprises one of a domain, a data source, a code complexity, and any combination thereof.

4. The method of claim 1, further comprising:
determining, by the processing system, at least one runtime associated with the matched subset of historic code segments to obtain an estimated code segment runtime, wherein the performance indicator is based on the estimated code segment runtime.

5. The method of claim 1, further comprising:
determining, by the processing system, at least one cost factor associated with the matched subset of historic code segments to obtain an estimated cost factor, wherein the performance indicator is based on the estimated cost factor.

6. The method of claim 5, wherein the cost factor is based on computational complexity.

7. The method of claim 1, further comprising:
extracting, by the processing system, metadata from the input code segment using an input classifier, wherein the input classifier comprises a preprocessing layer, a natural language processing layer, and a machine learning layer, wherein the encoding the plurality of classification categories is based on the metadata.

8. The method of claim 1, wherein the encoding the plurality of classification categories further comprises embedding, by the processing system, metadata into a continuous vector space to obtain metadata embeddings.

9. The method of claim 8, wherein the database of historic code segments comprises a graph database.

10. The method of claim 8, wherein the abstract representations of the historic code segments comprise historic metadata embeddings, and wherein the matching the input code segment to the subset of historic code segments further comprises determining, by the processing system, historic metadata embeddings closest to the metadata embeddings using a cosine similarity score.

11. The method of claim 1, wherein the similarity between the abstract representation of the input code segment and the abstract representations of the historic code segments is based on semantic similarity and weighted metadata attributes.

12. The method of claim 8, wherein the metadata embeddings comprise word embeddings.

13. The method of claim 1, further comprising:
providing, by the processing system, the optimized input code segment to a user and receiving feedback based on the optimized input code segment, wherein the feedback is used to refine future optimization recommendations.

14. A device, comprising:
a processing system including a processor; and
a memory that stores executable instructions that, when executed by the processing system, cause the processing system to perform operations, the operations comprising:
identifying a first code segment that, when submitted to a target system, causes the target system to perform an operation;
classifying the first code segment to obtain a classification comprising a plurality of classification categories;
determining a performance indicator of the operation according to the first code segment, wherein the performance indicator is based on at least one of the plurality of classification categories;
responsive to the performance indicator indicating a poor performance of the operation according to the first code segment:
encoding the plurality of classification categories into an abstract representation of the first code segment;
performing a similarity search in a database of historic code segments comprising abstract representations of the historic code segments to retrieve a group of similar code segments;
comparing the first code segment to a subset of historic code segments of the group of similar code segments according to a similarity between the abstract representation of the first code segment and the abstract representations of the historic code segments to obtain a similar subset of historic code segments; and
modifying the first code segment to obtain a second code segment having enhanced performance using an artificial intelligence enhancement algorithm informed by the similar subset of historic code segments.

15. The device of claim 14, wherein the encoding the plurality of classification categories further comprises embedding, by the processing system, metadata into a continuous vector space to obtain metadata embeddings.

16. The device of claim 15, wherein the abstract representations of the historic code segments comprise historic metadata embeddings, and wherein the comparing the first code segment to the subset of historic code segments further comprises determining, by the processing system, historic metadata embeddings closest to the metadata embeddings using a cosine similarity score.

17. The device of claim 15, wherein the database of historic code segments comprises a graph database.

18. The device of claim 14, wherein the similarity between the abstract representation of the first code segment and the abstract representations of the historic code segments is based on semantic similarity and weighted metadata attributes.

19. A non-transitory machine-readable medium, comprising executable instructions thereon that, when executed by a processing system including a processor, cause the processing system to perform operations, the operations comprising:
classifying a query to obtain a classification comprising a plurality of classification categories;
determining a performance indicator of the operation according to the query, wherein the performance indicator is based on at least one of the plurality of classification categories;
responsive to the performance indicator indicating a poor performance of the operation according to the query:
encoding the plurality of classification categories into an abstract representation of the query;
performing a similarity search in a database of historic queries comprising abstract representations of the historic queries to retrieve a group of similar queries;
comparing the query to a subset of historic queries of the group of similar queries according to a similarity between the abstract representation of the query and the abstract representations of the historic queries to obtain a similar subset of historic queries; and
modifying the query to obtain a modified query having enhanced performance using an artificial intelligence enhancement algorithm informed by the similar subset of historic queries.

20. The non-transitory machine-readable medium of claim 19, wherein the database of historic queries comprises a graph database.
